(19) United States
(12) Patent Application Publication
(10) Pub. No.: US 2016/0000055 A1
(43) Pub. Date: Jan. 7, 2016

(54) Minnow Collecting Fish Trap

(71) Applicants: Terry Best, Wichita, KS (US); Claude Cooper, Andover, KS (US); Lenny Trillo, Wichita, KS (US)

(72) Inventors: Terry Best, Wichita, KS (US); Claude Cooper, Andover, KS (US); Lenny Trillo, Wichita, KS (US)

(73) Assignee: AIR CASTLE VENTURES, INC., Wichita, KS (US)

(21) Appl. No.: 14/850,775

(22) Filed: Sep. 10, 2015

(51) Int. Cl. A01K 69/10; A01K 97/05

(52) U.S. Cl. CPC A01K 69/10; A01K 97/05

(57) ABSTRACT

A trap for collecting live minnows, the live minnows having a height, the trap incorporating a transparent case having a longitudinally opening longitudinal end; a first plurality of plates; a plurality of pivoting or fixed joints adapted for interconnecting first plurality of plates and the transparent case, the joints positioning the first plurality of plates at the transparent case's longitudinal end and further positioning the first plurality of plates to form at least a first inwardly extending funnel; a battery powered electric torch; a transparent cannister adapted for interconnecting the illuminating means and the transparent case, the transparent cannister positioning the electric torch for casting light outwardly from the transparent case; and a pair of suspension brackets connected operatively to the transparent case.

### FIELD OF THE INVENTION

This invention relates to sport fishing and fishing tackle and apparatus. More particularly, this invention relates to submersible traps adapted for capturing and collecting minnows and other small fish or aquatic animals for use as fishing bait.

### BACKGROUND OF THE INVENTION

Commonly known minnow traps ineffectively and insufficiently capture both commonly sized minnows and other larger bait fish or animals. Minnow traps often include a conical and inwardly extending minnow ingress ports which are sized for passage of a common minnow, and which may undesirably prevent the larger bait fish or other bait animals from entering the trap. Upon sizing such trap to include a larger ingress port for passage of the larger bait fish, smaller minnows passing therethrough may undesirably exit the trap through the enlarged port.

The instant inventive minnow trap solves or ameliorates the problems discussed above by providing a transparent and light emitting fish trap which incorporates specially configured movable and adjustable ingress cone forming elements.

### BRIEF SUMMARY OF THE INVENTION

A first structural component of the instant inventive minnow trap comprises a transparent case having a longitudinally opening longitudinal end. In the preferred embodiment, the transparent case is formed of a durable transparent plastic such as a polycarbonate, and the case is segmented, preferably vertically, to allow the case to be “broken down” during periods of non-use for purposes of compact shipment and storage.

Further structural components of the inventive minnow trap comprise a plurality of preferably transparent plates and first mounting means which are adapted for interconnecting the plates at and across the transparent case's longitudinal opening. In the preferred embodiment, the first mounting means are capable of positioning the plates to form at least a first, and preferably a plurality of inwardly extending cones which define inwardly opening a plurality of slot configured ingress ports at their inner vertices. In the preferred embodiment, such mounting means facilitate pivoting and/or sliding repositionings of the plates for adjustably varying the gap width of the cones' ingress ports.

Further structural components of the instant inventive minnow trap comprise illuminating means and second mounting means, the second mounting means preferably being adapted for positioning the illuminating means within the interior of the transparent case. In the preferred embodiment, the illuminating means comprise a battery powered electric torch having light emitting diodes capable of emitting green light having a wave length between 520 and 550 nanometers. In a preferred embodiment, the second mounting means comprise a sealed transparent cannister which encases the electric torch and is removably mounted upon the floor of the transparent case.

Further structural components of the inventive minnow trap comprise suspending means which are connected to the ceiling or side walls of the transparent case, and which facilitate tether or tie submersion of the trap within a lake, stream, or pond. In a preferred embodiment, the suspending means comprise a pair of “C” brackets which support the trap in the manner of a pair of shopping basket handles. Suitably, the suspending means may alternatively comprise a pair of straps or flexible loops, which adopt the “C” bracket configuration.

In use of the instant inventive minnow trap a fisherman may preliminarily adjust the trap's first mounting means in order to pivot the trap's plates to form and function as “V” configured funnel walls whose inner vertices define ingress port slots or gaps. Such ingress port slots are preferably set at a size or relative displacement which is only slightly wider than the height dimension of the bait fish which are sought to be trapped within the fish trap. Where minnows in a pond or lake are of average size, having a ventral to dorsal height of approximately ½″, the fisherman may suitably rotatably and/or slidably adjust the plates to form V's having the ½″ ingress port or gaps at their vertices.

Thereafter, the fisherman may actuate the trap's illuminating means to cast the preferably green fish attracting light from a central point within the trap outwardly through the trap's transparent walls. Thereafter, the fisherman may attach a tie or tether to the trap's preferably provided “C” bracket suspending means, and may lower the trap into the water. Minnows in the surrounding area are, especially during the darkness of night, attracted by the green light, and such minnows naturally swim into and between the trap's plate configured inwardly extending cones. As a result of the preferably transparent characters of the trap's side walls, ceiling, floor, and end plates, attempts by fish to exit the trap are generally directed away from the cone formed ingress points, effectively trapping the minnows.

Accordingly, objects of the instant invention include the provision of a minnow trap which incorporates structures as described above, and which arranges those structures in relation to each other in manners described above, for the achievement of the functions and benefits described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of preferred embodiment of the instant inventive minnow trap.

### DETAILED DESCRIPTION OF A PREFERRED EMBODIMENT

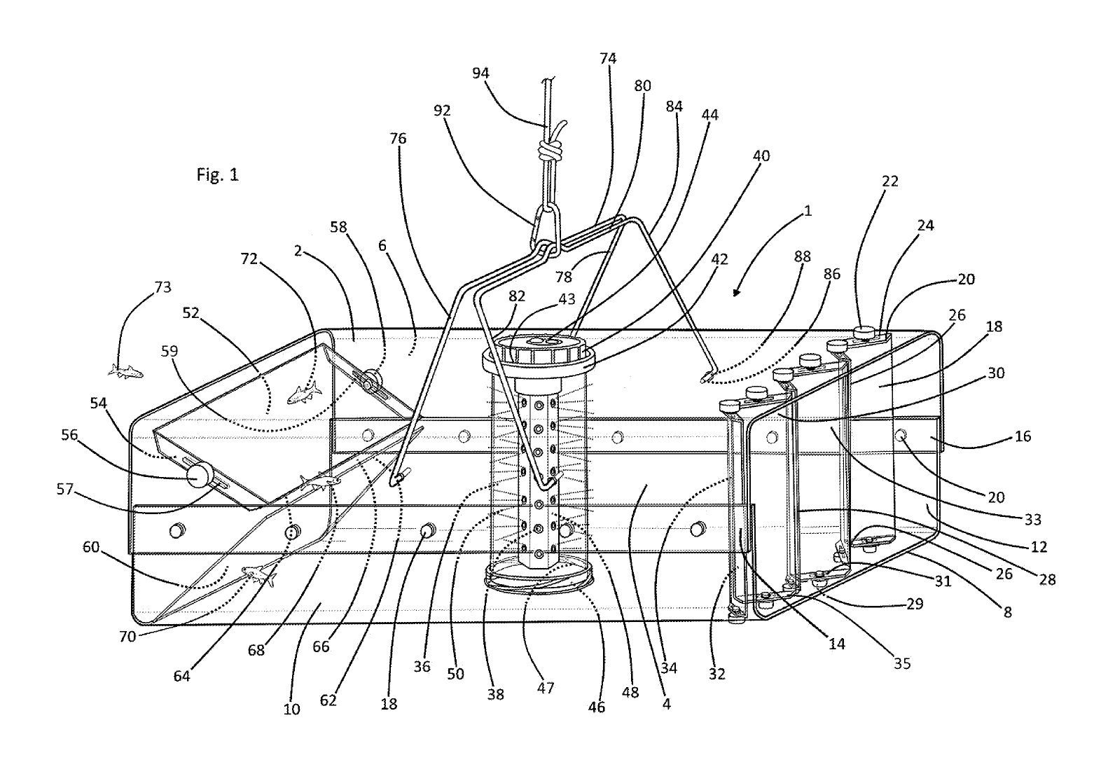

Referring now to the drawings and in particular to Drawing FIG. 1, a preferred embodiment of the instant inventive minnow trap is referred to generally by Reference Arrow 1. A major structural component of the minnow trap comprises a transparent case which is preferably composed of a durable transparent plastic, such as a polycarbonate. The case has a longitudinally opening longitudinal end, and according to the view of FIG. 1, such longitudinal opening is positioned leftwardly.

Further structural components of the instant inventive minnow trap comprise at least a first plurality of plates which are represented by plates 52 and 60. In the preferred embodiment, plates 52 and 60, and each of the other preferably provided plate components discussed below, are composed of the transparent polycarbonate plastic. Plates 52 and 60 have lateral lengths substantially equal to the interior lateral to oppositely lateral dimension of the transparent case.

Further structural components of the inventive minnow trap comprise first mounting means which are adapted for interconnecting the first plurality of plates with the transparent case, such means preferably being further adapted for positioning such plates to form at least a first inwardly extending funnel. In the FIG. 1 embodiment, such first mounting may suitably comprise welded, adhesively bonded, or wholly formed joints such as butt joints 61 at the lateral and oppositely lateral ends of plate 60. Such mounting means may be suitably utilized where the plate is to be fixedly and permanently positioned within the transparent case. For alternate purposes of movable positioning and re-positioning of the invention's plates, the first mounting means may alternatively or additionally comprise pivot and/or sliding joints which attach lateral and oppositely lateral ends of the plate respectively to lateral and oppositely lateral side walls of the transparent case.

In the FIG. 1 embodiment, such pivot/slide joints comprise combinations of mounting flanges 54 and 63, slide slots 57 and 69, and screw clamps 56 and 58. Upon tightening of screw clamps 56 and 58, plate 52 may be fixed at a desired location, such as the angular orientation depicted in FIG. 1. Upon loosening of the screw clamps 56 and 58, the plate 52 is advantageously freed for pivoting re-positioning about a lateral axis, and is freed for longitudinal re-positioning along slots 57 and 59. Retightening of the screw clamps 56 and 58 operatively fixes the plate 52 at a newly selected orientation. The screw clamping, pivoting, and slide slot adapted joints combined with the welded, adhesively bonded, or wholly formed joints depicted in FIG. 1 are intended as being representative of other commonly known joints or fasteners which are capable of fixedly positioning plate structures such as plates 60 and 52 within the hollow case.

In the FIG. 1 embodiment, the provided first mounting means advantageously position plates 52 and 60 to form at least a first inwardly extending funnel, the plates 52 and 60 together forming “V” walls of such funnel. Inward edges 64 and 62 of such plates advantageously form and define an adjustable ingress gap or port 66.

Further structural components of the instant inventive minnow trap comprise illuminating means and second mounting means which are adapted for operatively interconnecting the illuminating means and the transparent case. In the preferred embodiment, the illuminating means and their second mounting means are adapted for casting light from the interior of the transparent case outwardly and through the case's various walls and plates. Minnows 73 which swim at and about the exterior of the transparent case are attracted by such light and are drawn toward the case.

In a preferred embodiment, the illuminating means comprise a battery powered electric torch which incorporates a vertical column 48 which supports a 360° matrix of light emitting diodes 38. The electric torch preferably has an upper battery housing 40 which upwardly exposes a water proof on/off switch 44. Alternatively, electronic switching of the electric torch may be infra-red signal remote controlled. In order to facilitate operation of such electric torch within a water environment, an upwardly opening transparent cannister 36 is preferably provided, such cannister 36 downwardly receiving the electric torch and utilizing such torch's upper battery housing 40 as a hermetically sealing closure. In a suitable embodiment, an “O” ring seal (not depicted within views) and left-handed screw threads (not depicted within views) are provided for securely screwing the battery housing 40 onto and hermetically sealing the transparent cannister's upper opening. Alternatively, the upper opening of the cannister 36 may be covered by a pressure fitted cap. (Not within views.) The ceiling 2 of the transparent case preferably has a circular opening 43 for downwardly receiving the transparent cannister 36, the periphery of the opening 43 preferably being reinforced by a fixedly attached rim 42.

The lower end 47 of the transparent cannister 36 preferably has right-handed helical threads which allow the cannister to be securely and removably mounted within a threaded socket 46 which is fixedly attached to the floor 8 of the transparent case. Alternatively, the lower end of the cannister 36 may be received within a pressure fitted sleeve socket. (Not depicted within views.) In the preferred embodiment, the light emitting diodes 50 are of the type capable of emitting 520-550 nanometer wave length green light for enhanced minnow attraction.

The illuminating means 38, 40, 42 depicted in FIG. 2 is intended as being representative of other commonly known illuminators such as incandescent lights, fluorescent lights, chemi-luminescent lights, and various types of lights which are served by an electrical power cord. Correspondingly, the depicted 36, 42, 43, 46 second mounting means are intended as being representative of other commonly known mounting brackets or fixtures which are capable of securely positioning a lighting element within a water submerged space such as the interior space of the instant invention's transparent case.

Further structural components of the instant inventive minnow trap comprise suspending means which are connected operatively to the transparent case. In the depicted preferred embodiment, the suspending means comprise at least a first, and preferably a longitudinally spaced pair of “C” brackets 74 and 80, such brackets respectively having lateral and oppositely lateral arms 76, 78 and 82, 84. Each of the “C” bracket arms is preferably flexibly laterally splayable and has a distal inturned foot or pivot pin 86 which enters an eye socket 88. A carabiner-type “O” clip 92 is preferably provided for suspension of the trap from a rope 94. The “C” bracket configured suspending means advantageously pivot between the “A” configuration depicted in FIG. 1 and a longitudinally splayed configuration which permits access for insertions and extractions of the light cannister 36 into an out of the ceiling port 42, 43. Suitably, the “C” brackets may alternatively comprise laterally extending flexible loops. (Not depicted within views.)

The depicted “C” bracket configured suspending means 74, 78 is intended as being representative of other commonly known fastening assemblies which may securely attach a suspension tie, such as rope 94 to the transparent case. Further alternatively, the suspending means may comprise eye bolts or tie engaging eyes (not depicted within views) may be suitably, alternatively affixed to or positioned at the ceiling or side walls of the transparent case.

In the preferred embodiment, the inventive minnow trap has a second plurality of oppositely longitudinally positioned plates 18 and 26, and further preferably has a plurality of third plates 28, 30, 32, and 33. Similarly with the longitudinal pair of plates 52 and 60, the second plurality of plates 18 and 28 are positionable in “V” configurations for forming a second inwardly extending funnel. The third plurality of plates 26, 28, 32, and 33 may similarly form a third inwardly extending funnel.

To facilitate rotatable and/or longitudinal positioning of the oppositely longitudinal plates 18, 26, 28, 32, 33, the first mounting means preferably further comprise upper and lower flanges 20 and 35 upon each of said plates, such flanges being configured similarly with those of plate 52 to include slide slots 24 and 31. Such slots receive upper and lower screw clamps 22 and 29 which allow the oppositely longitudinally positioned plates to form a lateral series of ingress funnels having variably sized ingress ports 34.

In operation of the instant invention's laterally paired longitudinal pivot joints 54, 56, 57 and 58, 59, 63, a fisherman may rotatably and/or slidably move the inner edge 64 of plate 52 to the depicted first position wherein the edges 62 and 64 are vertically displaced from each other at a first position which accommodates a common ventral to dorsal height of a minnow 68, such dimension commonly being approximately ½″. Upon such positioning, the edges 62 and 64 form a minnow ingress port which prevents other minnows 70 and 72 which have previously entered the case from swimming outwardly therethrough. Egress of the minnows 68, 70, and 72 is advantageously prevented by the narrow gap spaces of the longitudinal and oppositely longitudinal ingress ports 66 and 34, and by the transparent character of the walls and plates of the trap.

In a preferred embodiment, the transparent case is vertically segmented to include a vertical “C” channel segment including the ceiling 2 and lateral and oppositely lateral walls 4 and 6. An oppositely vertical segment of the case is preferably similarly configured as a “C” channel, such segment having a floor 8 and lateral and oppositely lateral walls 10 and 12. Third mounting means are provided for fixedly, and preferably removably interconnecting the case's vertical and oppositely vertical segments, such means suitably comprising lateral and oppositely lateral lap joints 14 and 16 which are respectively secured by longitudinal arrays of magnetic fasteners or finger turnable screw fasteners 18 and 20. The invention's fastener 18,20 and lap joint 14,16 configured third mounting means are intended as being representative of other suitably substituted removable mounting means such as nut and bolt fasteners, snap fasteners, velcro fasteners, ridge and slot fasteners, hook and slot fasteners, and hinged joints. In the preferred embodiment of the inventive minnow trap, its components may be easily and conveniently disassembled for purposes of shipment to purchasing fishermen or for storage by fishermen. To effect such disassembly, arms 82, 84, 76, and 78 may be laterally splayed for retractions of pins 86 from eyes 80, such retractions allowing the “C” brackets 74 and 80 to be removed. Thereafter, the battery housing 40 may be turned counter-clockwise (against its preferred left-handed cannister mounting threads) to unscrew the base of the cannister 36 from the floor socket 46. Thereafter, the electric torch 40, 48, 36 may be upwardly removed from the case through ceiling port 42, 43.

Following removal of the electric torch 40, 48, 36, the longitudinal and oppositely longitudinal screw clamps 56, 58, and 22 may be unscrewed and removed to allow removals of plates 52, 18, 26, 33, 28, 30, and 32. Thereafter, the transparent case may be inverted and fasteners 18 and 20 may be released. Thereafter, the oppositely vertical “C” channel segment 8, 10, 12, may be reinverted and may be nestingly and compactly stored within the newly upwardly opening channel of the case's vertical “C” channel segment 2, 4, 6.

Upon such inversion and nesting receipt of the oppositely vertical “C” channel segment 8, 10, 12 within the channel of the vertical “C” channel segment 2, 4, 6, each of the other removed components discussed above may be conveniently and compactly stored within newly upwardly exposed channel of the oppositely vertical “C” channel 8, 10, 12. Thereafter, the entirety of the disassembled and compactly configured minnow trap may be slidably inserted into and received within a shipping or storage carton (not depicted within views) having a longitudinal dimension slightly longer than the longitudinal length of the minnow trap, having a lateral dimension slightly larger than the lateral width of the minnow trap, and having a vertical dimension only slightly greater than the downward extensions of walls 4 and 6 from ceiling 2.

While the principles of the invention have been made clear in the above illustrative embodiment, those skilled in the art may make modifications in the structure, arrangement, portions and components of the invention without departing from those principles. Accordingly, it is intended that the description and drawings be interpreted as illustrative and not in the limiting sense, and that the invention be given a scope at least commensurate with the appended claims.

1. A fish trap for collecting live minnows, the live minnows having a height, the fish trap comprising:
(a) a transparent case having a longitudinally opening longitudinal end;
(b) a first plurality of plates;
(c) first mounting means adapted for interconnecting first plurality of plates and the transparent case, the first mounting means positioning the first plurality of plates at the transparent case's longitudinal end and further positioning the first plurality of plates to form at least a first inwardly extending funnel;
(d) illuminating means;
(e) second mounting means adapted for interconnecting the illuminating means and the transparent case, the second mounting means positioning the illuminating means for casting light outwardly from the transparent case; and
(f) suspending means connected operatively to the transparent case.

2. The fish trap of claim 1 wherein the transparent case has an oppositely longitudinally opening oppositely longitudinal end, and further comprising a second plurality of plates, the first mounting means being further adapted for positioning the second plurality of plates at the transparent case's oppositely longitudinal end and for positioning the second plurality of plates to form a second inwardly extending funnel.

3. The fish trap of claim 2 further comprising a third plurality of plates, the first mounting means being further adapted for positioning the third plurality of plates at the transparent case's longitudinal end and for positioning the third plurality of plates to form a third inwardly extending funnel.

4. The fish trap of claim 3 wherein each plate among the first, second, and third pluralities of plates has an inner edge, and wherein each funnel among the first, second and plurality of third inwardly extending funnels has a minnow ingress port, each minnow ingress port being defined by a pair of said plates' inner edges.

5. The fish trap of claim 4 wherein the first mounting means comprise a plurality of pivot joints, each joint among the plurality of pivot joints being adapted for moving one of the plates' inner edges between first and second positions, said one of the plates' inner edges being displaced a distance equal to the minnow height from another of the plates' inner edges upon movement to the first position, said one of the plates' inner edges being further displaced from said other plates' inner edge upon movement to the second position.

6. The fish trap of claim 5 wherein each pivot joint comprises a slide slot.

7. The fish trap of claim 6 wherein each plate among the first, second, and third pluralities of plates is transparent.

8. The fish trap of claim 7 wherein the illuminating means comprise a plurality of light emitting diodes.

9. The fish trap of claim 8 wherein the light emitting diodes are adapted for emitting green light.

10. The fish trap of claim 1 wherein the second mounting means comprise a transparent cannister.

11. The fish trap of claim 1 wherein the transparent case comprises vertical and oppositely vertical “C” channel segments.

12. The fish trap of claim 11 further comprising third mounting means connected operatively to the vertical and oppositely vertical “C” channel segments, the third mounting means being adapted for removably attaching the vertical “C” channel segment to the oppositely vertical “C” channel segment.

13. The fish trap of claim 12 wherein the oppositely vertical “C” channel segment is fitted for, upon detachment of the third mounting means and upon inversion of the oppositely vertical “C” channel segment with respect to the vertical “C” channel segment, nesting within the vertical “C” channel segment.

14. The fish trap of claim 13 wherein the third mounting means comprise lateral and oppositely lateral lap joints.

15. The fish trap of claim 14 wherein the third mounting means further comprise a plurality of fasteners positioned at the lateral and oppositely lateral lap joints.

16. The fish trap of claim 1 wherein the transparent case has lateral and oppositely lateral walls, and wherein the suspending means comprise at least a first “C” bracket, said bracket having a pair of arms, said arms engaging the transparent case's lateral and oppositely lateral sides.

17. The fish trap of claim 16 wherein the suspending means comprise a second “C” bracket, the second “C” bracket engaging the transparent case longitudinally from the at least first “C” bracket.

18. The fish trap of claim 17 wherein the at least first and second “C” brackets' engagements with the transparent case comprise pivot joints.

19. The fish trap of claim 18 wherein the transparent case is composed of a polycarbonate plastic.
